(19) United States
(12) Patent Application Publication
(10) Pub. No.: US 2026/0303570 A1
(43) Pub. Date: Oct. 1, 2026

(54) TECHNIQUES FOR PROVIDING DYNAMIC APPLICATION PERMISSIONS ON A CELLULAR NETWORK

(71) Applicant: T-Mobile USA, Inc., Bellevue, WA (US)

(72) Inventors: Dave Edward Reimer, Spring Hill, KS (US); Jeff H. Bryan, Bellevue, WA (US); Ryan Christopher Lindstrom, De Soto, KS (US); Beth Diane Webb, Overland Park, KS (US); Peter Kimari Mwangi, Leawood, KS (US)

(21) Appl. No.: 19/092,920

(22) Filed: Mar. 27, 2025

(51) Int. Cl. H04L 9/40; H04W 12/08

(52) U.S. Cl. CPC H04L 63/0263; H04L 63/0807; H04W 12/08

(57) ABSTRACT

Techniques are described herein for implementing dynamic permissions for software applications on user equipment. The techniques may be performed on a user equipment device and may comprise maintaining a set of local rules that relate to software application permissions, receiving a request associated with an action to be performed in relation to a software application. The techniques may further comprise identifying, from the set of local rules, a subset of the set of local rules related to the request, making a determination about whether the request should be granted based on the subset of the set of local rules, and upon determining that the request should be granted, relaying the request to an operating system of the user equipment device to cause the user equipment device to execute one or more actions associated with the request.

### BACKGROUND

Cellular networks have evolved greatly over recent years. One of the most recent changes in cellular networks is the adoption of the fifth-generation (5G) technology standard for broadband cellular networks. The adoption of the 5G technology standard by cellular networks has enabled the implementation of new applications/services on a wide variety of electronic devices.

Cellular network operators may provide third-party software application developers with the ability to make available various software applications that operate on those cellular networks. In many cases, software developers may require permissions (e.g., with a device manufacturer) to access and integrate advanced network capabilities like location data, network quality, and specific network features into their applications, which enables them to build innovative services based on cellular network functionalities. However, once a developer receives such permissions, the cellular network operator may be unable to manage actions taken by the developer or to prevent that developer from changing the terms of operation of its respective software application.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment in which operators of cellular networks are capable of managing permissions between third-party software developers and device manufacturers in accordance with at least some embodiments.

FIG. 2 depicts a component diagram of an example system to be implemented in a network in order to enable implementation of dynamic permissions management in accordance with some embodiments.

FIG. 3 depicts a block diagram illustrating relationships between various components that may be implemented in accordance with embodiments.

FIG. 4 depicts a block diagram illustrating dynamic implementation of software application features in accordance with embodiments.

FIG. 5 depicts a flow diagram illustrating an exemplary process for enabling dynamic implementation of application permissions in accordance with at least some embodiments.

FIG. 6 shows an example computer architecture for a computing device capable of executing program components for implementing the functionality described above.

### DETAILED DESCRIPTION

This disclosure describes techniques that may be performed to provide dynamic permissions management on a user equipment device in relation to software applications. In embodiments, a local set of rules is generated in relation to a user equipment and provided to that user equipment to be maintained locally. Upon receiving a request related to a software application (e.g., installation/update), a permissions management module implemented on the user equipment may make a determination as to whether that request should or should not be approved based on the local set of rules. Provided that a determination is made that the request should be granted, the permissions management module may interact with an operating system of the user equipment in order to cause that user equipment to execute one or more actions associated with the received request. In some embodiments, the permissions management module may provide a token to the operating system in order to provide proof of authorization for the request.

In conventional systems, each developer of a software application must generally work with a manufacturer of a user equipment in order to establish permissions related to their various software applications on those user equipment. This requires the developer to manage permissions for a software application across a number of different types of user equipment manufactured by different entities. Additionally, once a developer has established such permissions, an operator of a cellular network on which the user equipment operates may be unable to control and/or optimize software installations/updates. This can lead to situations in which the software developer is able to push updates to user equipment even when those updates would violate rules imposed on a cellular operator (e.g., a carrier), would be performed at suboptimal times, or would use resources that should be reserved for more critical applications.

Embodiments of the disclosure provide for a number of advantages over conventional systems. For example, embodiments of the disclosed system allow for optimal permissions management by a network operator in relation to software applications installed on user equipment. Embodiments allow for a single entity (e.g., the cellular network operator) to manage permissions for the user equipment (e.g., via tokens generated by respective device manufacturers). Additionally, embodiments of the disclosure allow for the network operator to dynamically alter permissions for a software application as new rules are imposed on that network operator.

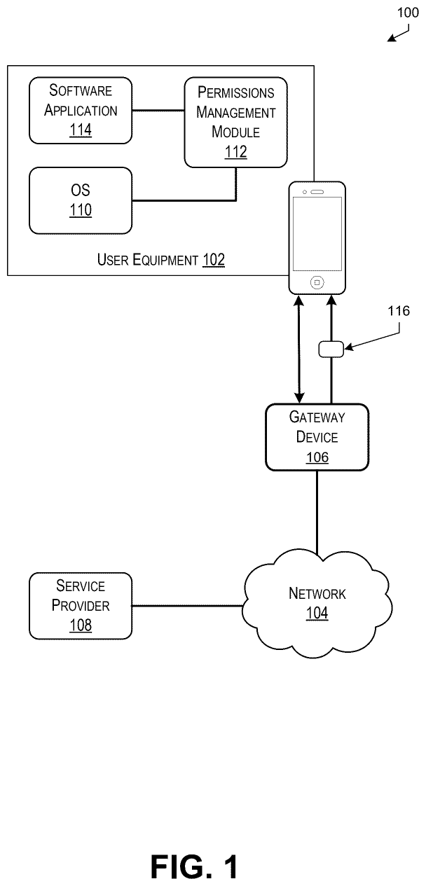

FIG. 1 depicts an example environment in which operators of cellular networks (or other suitable networks, such as WiFi networks) are capable of managing permissions between third-party software developers and device manufacturers in accordance with at least some embodiments. In the environment 100, a user equipment 102 may be in communication with a network 104 via a gateway device 106. The network 104 may be used to access one or more service provider 108 that maintains access to software applications/services to be made available via that network 104.

The user equipment 102 can correspond to or include devices capable of communication using various connectivity standards. For example, a 5G communication channel can use millimeter wave (mmW) access frequencies of 28 GHz or more. In some implementations, a user equipment 102 can operatively couple to a gateway device 106 over a long-term evolution/long-term evolution-advanced (LTE/LTE-A) communication channel, which is referred to as a 4G communication channel. In some non-limiting examples, user equipment can include handheld mobile devices (e.g., smartphones, portable hotspots, tablets, etc.); laptop devices; wearable devices; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provides data to a remote server over a network; IoT devices such as wirelessly connected smart home appliances, etc.

A user equipment 102 can communicate with various types of access points and network equipment at the edge of a network including macro eNBs/gNBs, small cell eNBs/gNBs, relay base stations, and the like. A user equipment can also communicate with other user equipment either within or outside the same coverage area of a base station via device-to-device (D2D) communications.

The network 104 of FIG. 1 may be maintained and/or operated by one or more service providers, such as one or more wireless carriers (“operators”), that provide mobile (e.g., IMS-based) services to users (sometimes called “subscribers”) who are associated with user equipment, such as the user equipment 102. The network 104 may represent any suitable type of network, including, but not limited to, an IP Multimedia Subsystem (IMS) network or other SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of an IMS network may communicate using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

A gateway device 106 may be any suitable electronic device that is capable of managing access to one or more networks. In some embodiments, the gateway device 106 may be, or may be implemented within, a base station. A base station is a type of network access node (NAN) that can also be referred to as a cell site, a base transceiver station, or a radio base station. In some embodiments, the gateway device 106 may include one or more radio access units that provide service (e.g., cellular data service) to a user equipment 102 within a geographic area surrounding the gateway device 106 (e.g., a cell). The environment 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 602.11 access point. In some embodiments, a group of neighboring base stations/gateway devices 106 may be managed by a base station controller (not shown).

A gateway device 106 implemented as a base station may include one or more transmission mechanisms (e.g., a radio transceiver) capable of enabling wireless communication with a number of user equipment. Such base stations may be distributed over an area in a sufficiently dense manner such that multiple user equipment (e.g., mobile communication devices) in communication with the network can communicate with each other or with a terrestrial network. In some embodiments, the gateway device 106 may include one or more sensors configured to collect information about the gateway device 106 itself or an environment in which the gateway device 106 is situated. Additionally, the gateway device 106 may include one or more mechanical means of adjusting/configuring components of the gateway device. For example, the gateway device may include a radio antenna as well as a motorized mechanism for adjusting a position of the radio antenna.

A gateway device 106 implemented as a base station can wirelessly communicate with multiple user equipment 102 within wireless communication range via one or more base station antennas. The environment 100 can include base stations of different types (e.g., macro and/or small cell base stations). In some implementations, there can be overlapping geographic coverage areas (e.g., cells) for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.). In some embodiments, the network may operate using a fixed wireless access (FWA) connection. FWA is a type of wireless technology, e.g., 5G or 4G LTE wireless technology, that enables fixed broadband access using radio frequencies rather than cables.

A communication link between a user equipment 102 and a gateway device 106 may include uplink (UL) transmissions from the user equipment 102 to the gateway device 106, and/or downlink (DL) transmissions from the gateway device 106 to the user equipment 102. The downlink transmissions can also be called forward link transmissions while the uplink transmissions can also be called reverse link transmissions. Each communication link includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links can transmit bidirectional communications using frequency division duplex (FDD) (e.g., using paired spectrum resources) or Time division duplex (TDD) operation (e.g., using unpaired spectrum resources). In some implementations, the communication links include LTE and/or mmW communication links.

In embodiments, the user equipment 102 may include a computer-readable memory as well as a set of executable instructions that, when executed by one or more processors of the user equipment, can cause that user equipment to perform various functions. Such a set of executable instructions may include an operating system (OS) 110, a permissions management module 112, and one or more software application 114.

An operating system 110 is typically software that supports a computer's basic functions, such as scheduling tasks, executing applications, and controlling peripherals. The operating system 110 may be initially installed on a user equipment by a manufacturer of that user equipment 102. The operating system 110 may, in addition to performing basic operations on the user equipment, make determinations about what permissions are available to each of the various software applications. For example, when a software application 114 requests to download a more recent version, the operating system 110 may make a determination as to whether that software application has permission to do so. In some cases, such permission may be determined based on a token received in relation to the request made by the software application.

A permissions management module 112 may be a module (e.g., a software application) configured to manage permissions for various software applications 114 installed upon, or to be installed upon, the user equipment 102. In embodiments, the permission management module 112 may maintain one or more tokens issued by a manufacturer of the user equipment that can be used to indicate permissive status. In embodiments, rather than provide a permission token to each individual software application to allow it to interact with the operating system 110 directly, the software application 114 may be required to route requests that require permissions through the permissions management module 112.

The permissions management module 112 may be configured to, upon receiving a request related to a software application 114 (e.g., installation, update, uninstallation, version roll back, etc.), the permissions management module 112 may be configured to make a determination about whether or not the request should be approved based on locally and/or remotely stored rules data. Upon making a determination that the request should be approved, the permissions management module 112 may be further configured to make the request to the operating system 110 on behalf of the software application 114. In such cases, the permissions management module 112 may be configured to provide a token to the operating system 110 along with the request. The operating system 110 may then cause the user equipment to execute the request. For example, the operating system 110 may cause the user equipment 102 to download or retrieve a software update or installation packet 116 from the network 104 via the gateway device 106.

In accordance with various embodiments described herein, the terms “user equipment (UE),” “wireless communication device,” “wireless device,” “communication device,” “mobile device,” and “client device,” may be used interchangeably herein to describe any user equipment (e.g., the user equipment 102) that is capable of transmitting/receiving data over the network 104, perhaps in combination with other networks. A users can utilize the user equipment 102 to communicate with other users and associated user equipment via the network. For example, a cellular network operator may offer multimedia telephony services that allow a subscribed user to call or message other users via the network using his/her user equipment 102. A user can also utilize the user equipment 102 to receive, provide, or otherwise interact with various different network-based services by accessing the network 104. In this manner, an operator of the network (e.g., a carrier) may offer any type of network-based service, such as, telephony services, emergency services (e.g., E911), gaming services, instant messaging services, presence services, video conferencing services, social networking and sharing services, location-based services, push-to-talk services, and so on.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

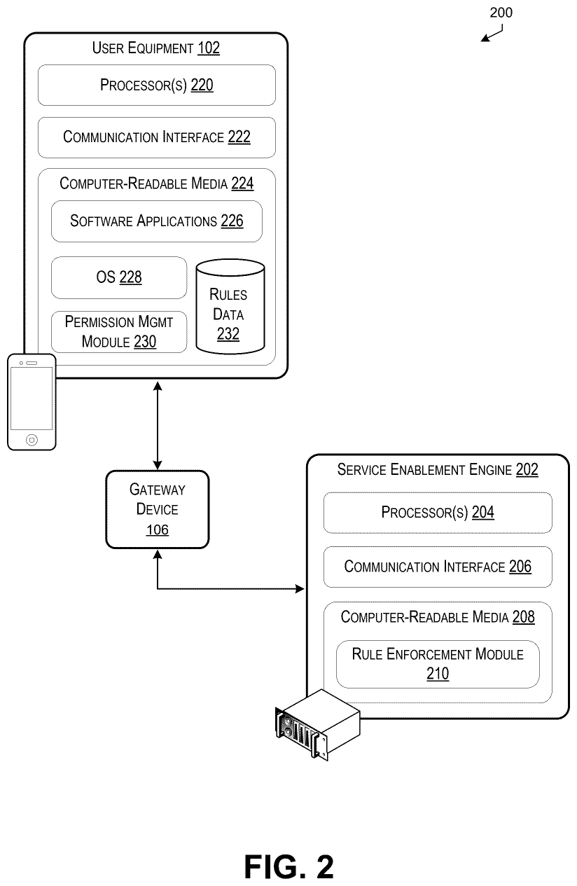

FIG. 2 depicts a component diagram of an example system 200 to be implemented in a network (e.g., a cellular network) in order to enable implementation of dynamic permissions management in accordance with some embodiments. As depicted in FIG. 2, a service enablement engine 202 may be executed as a combination of hardware (e.g., a network node) and software in wireless communication with a user equipment 102 operated by a user. The connection between the user equipment 102 and the service enablement engine 202 may be made over a gateway device 106.

In some embodiments, the service enablement engine 202 is implemented in communication with a gateway device 106. Gateway device 106 may be an example of the gateway device 106 as described in relation to FIG. 1 above. It should be noted that a network node (or any other described computing component) on which the service enablement engine 202 is implemented may include a single computing device (e.g., a server device) or a combination of computing devices. In some cases, such a network node may be implemented as a virtual device/system (e.g., via virtual machines implemented within a cloud computing environment).

As illustrated, the service enablement engine 202 may include one or more hardware processors 204 configured to execute one or more stored instructions. Such processors 204 may comprise one or more processing cores. Further, the service enablement engine 202 may include one or more communication interfaces 206 configured to provide communications between the service enablement engine 202 and other devices, such as the user equipment 102 or any other suitable electronic device.

The service enablement engine 202 may also include computer-readable media 208 that stores various executable components (e.g., software-based components, firmware-based components, etc.). The computer-readable media 208 may store components to implement functionality described herein. While not illustrated, the computer-readable media 208 may store one or more operating systems utilized to control the operation of the one or more devices that comprise the service enablement engine 202. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 208 may include portions, or components, that configure the service enablement engine 202 to perform various operations described herein. For example, the computer-readable media 208 may include some combination of components configured to implement the described techniques. Particularly, the service enablement engine 202 may include a component configured to determine generate rules data to be implemented on a user equipment (e.g., rule enforcement module 210). Additionally, the computer-readable media 208 may further maintain one or more databases.

A rule enforcement module 210 may be configured to, when executed by the processors 204, generate and/or update a ruleset to be provided to a user equipment to provide for dynamic implementation of permission management. In some cases, this may involve obtaining some combination of information about an operator (or an account) of the user equipment, a type of the user equipment, and/or local/regional rules. For example, the rule enforcement module 210 may be configured to retrieve information about a user/account associated with a user equipment from a computing device that manages account information for subscribers (e.g., a Home Subscriber Server (HSS)). Additionally, the rule enforcement module 210 may retrieve information about one or more capabilities of the user equipment (e.g., based on a type or model of the user equipment). Further, the rule enforcement module 210 may retrieve information about rules/regulations that pertain to a geographic region within which the user equipment is currently located.

In embodiments, the rule enforcement module 210 aggregates information about various rules that are relevant to a user equipment to be included in rules data 232 that is provided to (and stored locally on) that user equipment. Such rules may be generated from the information obtained about the user equipment as noted above and may include an indication of when/what software applications can be downloaded/updated, what features can be implemented within such software applications, or any other suitable restrictions on software applications. The rule enforcement module 210 may then be configured to provide the generated rule data 232 to the user equipment to be stored and used locally. In some cases, the rule enforcement module 210 may be configured to generate the rules data 232 on a periodic basis (e.g., every day, etc.). In some cases, the rule enforcement module 210 may be configured to generate the rules data 232 upon detecting that the user equipment 102 has entered a different geographic region. In some cases, the rule enforcement module 210 may be configured to generate the rules data 232 when a request is received from the user equipment 102 to generate such rules data.

The user equipment 102 may be an example of a user equipment 102 as described in relation to FIG. 1 above. As noted elsewhere, a user equipment 102 may include any suitable electronic device configured to interact with a network.

In embodiments, the user equipment 102 may include one or more hardware processors 220 configured to execute stored instructions. Such processor(s) 220 may comprise one or more processing cores. Further, the user equipment 102 may include one or more communication interfaces 222 configured to provide communications between the user equipment 102 and other devices, such as a service enablement engine 202 or another suitable electronic device.

In embodiments, the user equipment 102 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the user equipment 102. In some examples, the operations performed by devices as described herein may be supported by one or more devices similar to user equipment 102. Stated otherwise, some or all of the operations performed by a user equipment, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the user equipment 102 to perform various operations described herein. For example, the computer-readable media 224 may include some combination of components configured to implement the described techniques. In embodiments, the computer-readable media 224 of the user equipment 102 may include an operating system (OS) 228 as well as one or more software application(s) 226. The computer-readable media 224 may further include a component configured to make a determination about whether a request related to a software application (e.g., installation, update, uninstallation, version rollback, etc.) should be authorized (e.g., permission management module 230). Additionally, the computer-readable media 224 may further maintain one or more databases, such as a data store holding software updates to be implemented at a later time (e.g., rules data 232).

A software application 226 may be any suitable set of computer-executable instructions that causes the user equipment 102 to perform a function. In embodiments, the software application 226 may be supported by a remote server, such as the service provider 108 as described in relation to FIG. 1 above. In other words, when executed, the software application may cause the user equipment 102 to communicate with a remote server to perform at least a portion of the functionality provided by that software application 226 (or to download software application data). The network traffic generated during such a communication may be transmitted to the gateway device 106 to be routed to its intended destination device. In some cases, a software application 226 installed on user equipment 102 may request that its version be updated when a determination is made that the current installed version of the software application is not the most recent version of the software application available.

A permission management module 230 may be configured to, when executed by the processors 220, receive a request related to a software application and to make a determination about whether that request should be granted. Upon receiving such a request, the permission management module 230 may be configured to determine which rules stored in rules data 232 are relevant to the request based on attributes of the software application related to the request in relation to criteria associated with the respective rules. In some cases, such a determination may be made based on a type or priority of the software application that the request relates to. For example, a determination may be made based on information about a user that the user equipment is being operated by a minor or a government employee. Upon making this determination, the permission management module 230 may make a determination as to whether or not to grant the request based on a priority or criticality of the related software application. In this example, only requests related to critical software applications may be granted when the user is a minor or a government employee.

In embodiments, the permission management module 230 may be configured to not only make a determination about what applications can be installed/updated/uninstalled and/or rolled back on the user equipment 102, but also about what individual features can be implemented by a software application on the user equipment. In some cases, this may involve identifying a set of configuration settings to be applied to the software application or a version of the software application to be installed based on the rules data 232.

Availability of software applications/services may vary based on location based on local/regional rules (e.g., based on local laws). In some cases, some software applications/services may only be made available in particular geographic regions. Alternatively, certain features (e.g., geolocation tracking) may not be available in certain geographic regions.

In embodiments, upon making a determination that a request related to a software application is to be granted, the permission management module 230 may relay the request to the operating system 228. In some cases, the permission management module 230 may provide a token (or another suitable indication of authorization) to the operating system 228 to prove that the permission management module 230 has authorization to make such a request. In such cases, the token may be a token that is provided to the operator of the network (e.g., carrier) by a manufacturer of the user equipment. Upon receiving the request (and token), the operating system may cause the user equipment to initiate/execute that request.

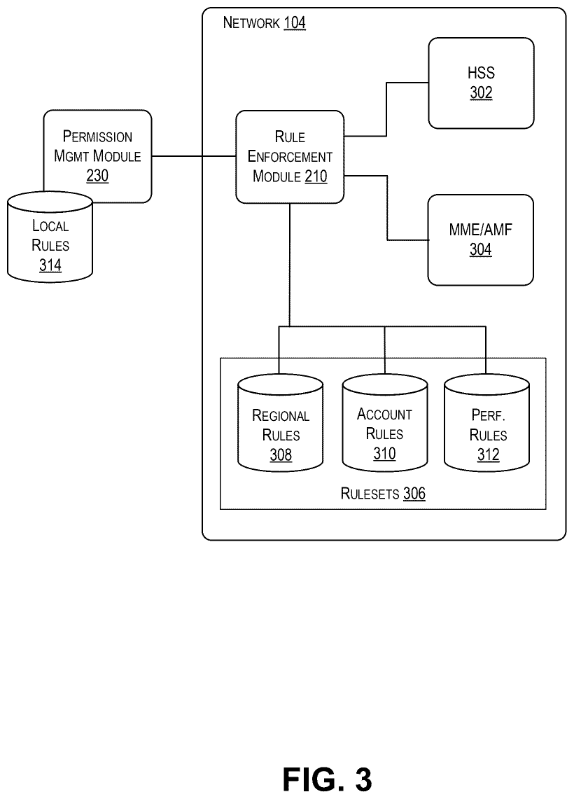

FIG. 3 depicts a block diagram illustrating relationships between various components that may be implemented in accordance with embodiments. As noted elsewhere, a permission management module 230 implemented within a user equipment (e.g., user equipment 102) may be in communication with a rule enforcement module 210 implemented on a network node operating within a network 104 (e.g., a cellular network). In embodiments, the permission management module 230 may be an example of the permission management module 230 as described in relation to FIG. 2 above. Likewise, the rule enforcement module 210 may be an example of the rule enforcement module 210 as described in relation to FIG. 2 above.

In embodiments, a network node on which the rule enforcement module 210 is implemented may be in communication with a Home Subscriber Server (HSS) 302 as well as one or more of a Mobility Management Engine (MME) or an Access and Mobility Management Function (AMF) 304 (depending on the protocols used by the network). The network node on which the rule enforcement module 210 is implemented may also have access to a number of rulesets 306 used to manage permissions.

The HSS 302 is typically a master user database that supports the network nodes that handle the calls/sessions. It contains user profiles, performs authentication and authorization of the user, and can provide information about the home location of a user. A user profile may be associated with each user equipment 102 and may contain information about the current user.

The MME/AMF 304 is typically a network node that performs functions such as tracking user device location, and managing how user equipment connect between cell towers (e.g., during handoffs). The MME/AMF 304 may track a current physical location of various user equipment operating on the network. The MME/AMF 304 may further manage security keys and protect against malicious attacks on the network.

In embodiments, the rulesets 306 may include a number of different sets of rules to be implemented under various conditions. By way of non-limiting example, the rulesets 306 may include regional rules 308 that include rules related to a specific geographic region or area, account rules 310 that relate to account/customer types, and performance rules 312 that relate to technological capabilities of, or available to, user equipment.

Upon receiving a request to generate local rules 314 in relation to a particular user equipment, a rule enforcement module 210 may be configured to retrieve information about that user equipment. In some cases, this may involve retrieving information about a current location of the user equipment from an MME or AMF 304 as well as retrieving information about a user that operates the user equipment from a HSS 302. When selecting rules from the rulesets 306 to be included in local rules 314, the rule enforcement module 210 may be configured to identify rules that are relevant to the particular user equipment.

For example, the rule enforcement module 210 may identify a number of rules from the regional rules 308 that pertain to a region within which the user equipment is currently determined to be located. In another example, the rule enforcement module 210 may select rules that pertain to capabilities of the user equipment, such as various hardware components installed in the user equipment or a network slice available to the user equipment. In yet another example, rules may be selected from the account rules based on a type of account associated with the user of the user equipment. By way of illustration, upon making a determination that the user is a minor (e.g., a person under 18 years of age), the rule enforcement module 210 may select rules that relate to minors. In such cases, the rules may limit which/when software applications can be installed/updated on the user equipment.

Upon generating a set of local rules 314, the rule enforcement module 210 may provide that set of local rules 314 to the user equipment to be stored in local memory. When the user equipment receives a request related to a software application (e.g., to install the software application or update that software application to another version), a permission management module 230 executed on the user equipment may make a determination about whether the request should be permitted based on whether various conditions associated with the request and/or software application corresponds to criteria associated with the rules included in the local rules 314.

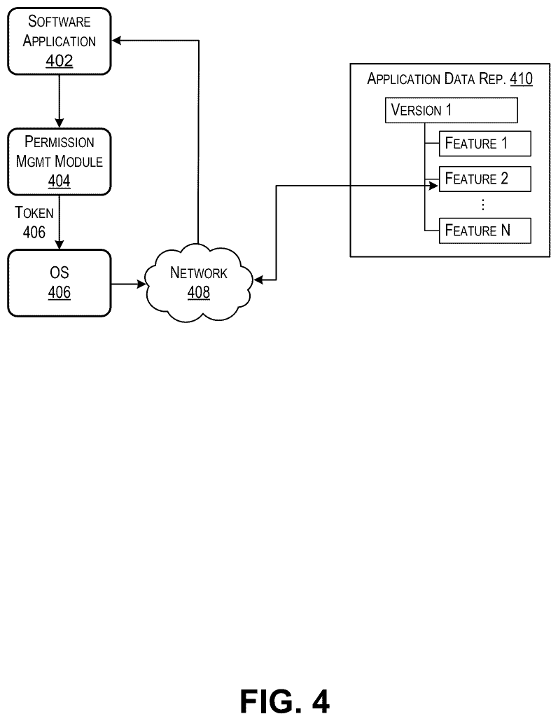

FIG. 4 depicts a block diagram illustrating dynamic implementation of software application features in accordance with embodiments. More particularly, FIG. 4 depicts interactions between various components as implemented in embodiments of the disclosure as described. Such components may include a software application 402, a permission management module 404, and an operating system 406 as implemented on a user equipment.

In embodiments, a request is received by the permission management module 404 in relation to a software application 402. By way of nonlimiting example, the request may be a request to install or update the software application. In some cases, the request is received from the software application (e.g., via an Application Programming Interface (API) call) upon detecting that a current version of the software application 402 should be updated to a more recent version. In some cases, the request is received from a computing device that is external to the user equipment, such as a service provider (e.g., service provider 108 as described in relation to FIG. 1 above) to install a software application onto the user equipment.

As noted elsewhere, the user equipment may maintain a set of local rules to be used to determine permissions related to software application requests. Upon receiving such a request, the permission management module 404 may initially identify a subset of the local set of rules that relates to the software application request. In some cases, this may involve identifying a subset of the local rules that relate to the type of software application that the request relates to. For example, if the software application is a gaming application, a subset of rules may be identified within the set of local rules that relate specifically to gaming applications. In this example, the local rule set may include a rule that specifies an Entertainment Software Ratings Board (ESRB) rating of gaming applications that can be installed on the user equipment. Additionally, the subset of rules may be identified based on the type of the request. For example, different rules may be identified based on whether the request is a request to update the software application or alternatively a request to install the software application. For example, the local rule set may restrict new software installations from being executed to certain time slots and may further require user authorization. Alternatively, the local rule set may allow updates to software applications to be executed at any time and without user authorization.

Upon identifying a subset of the local rules that relate to the request, the permission management module 404 may be configured to determine whether the received request should be granted. In embodiments, this may involve making a determination as to whether aspects of the request/software application meet one or more conditions associated with the various rules. By way of illustration, a determination may be made as to whether the request was received at a time that is within a timeslot that the rules permit the request to be executed. In another illustrative example, a determination may be made as to whether a rating associated with the software application to be installed is within an acceptable range of ratings.

In some embodiments, in addition to making a determination as to whether a request should be granted, the permission management module 404 may make a determination as to a particular version of the software application that should be installed on the user equipment or one or more particular features that should be enabled or disabled in relation to the request.

By way of a first example, if the user of the user equipment is a minor or a government employee, the local set of rules may include a rule that prevents location tracking of that user equipment. In such cases, the permission management module 404 may make a determination that while the request related to the software application should be granted, the location tracking feature of the software application should be disabled by default. Note that this may not prevent a user of the user equipment from enabling the feature at a later date.

In another example, a local set of rules may be generated for a user equipment to include rules related to particular hardware capabilities that the user equipment has (e.g., if the user equipment does not include a camera, then the set of local rules may be generated to include a rule that camera functionality features should not be implemented on the user equipment. Alternatively, a local set of rules may be generated for a user equipment to include rules related to capabilities/services that are available to the user equipment. By way of illustration, a determination may be made as to a particular network slice that is available to the user equipment based on an account associated with the user equipment. In such cases, the set of local rules may be generated to include a rule that allows the installation of software applications that require the use of that network slice to operate.

In another example, permissions management may be determined based on customer type. For example, if the user of the user equipment is identified as a “premium” user (e.g., a user having an elite status), the local set of rules may include a rule that an expanded set of features available to premium users be made available to the software application. In such cases, a determination may be made that each of those expanded set of features available for the software application should be included in, and enabled within, the software application.

Upon making a determination that a particular version of the software application should be installed on the user equipment or that one or more particular features should be enabled or disabled, the permission management module 404 may modify the request to indicate that determination. For example, upon receiving a request to install a first version of a software application on the user equipment, the permission management module 404 may make a determination that a different version of that software application should be installed instead based on the set of local rules. In such cases the permission management module 404 may modify the request to install the first version of the software application to instead request installation of the different version of the software application.

Upon making a determination that the request should be granted, the permission management module 404 may be configured to relay that request (or the modified request) to an operating system of the user equipment. In some embodiments, the permission management module 404 may also provide a token to the operating system along with the request in order to prove that the request is authorized. In some embodiments, the token may be generated/provided by a manufacturer of the user equipment. Alternatively, the token may be generated (e.g., via a hash function) from information provided by the manufacturer of the user equipment.

Upon receiving the request, the operating system 406 may cause the user equipment to execute one or more actions related to the request. In embodiments, this may involve causing the user equipment to relay an installation request to a network node (or service provider) reachable over a network 408 to access an application data repository 410. The user equipment is then caused to retrieve the application data from the application data repository 410. In some cases, where no specific version/features are specified, the user equipment may retrieve data packets related to the latest version of the software application. In some cases, where a specific version and/or features are specified, the data packets retrieved by the user equipment may relate to the indicated version and/or the indicated features. In some cases, the data packets may relate to a version of the software application that includes all of the available features (e.g., features 1-N) but may also include configuration settings indicating which features are enabled/disabled in that version of the software application. The operating system 406 may then cause the user equipment to install/update the software application based on the received data packets.

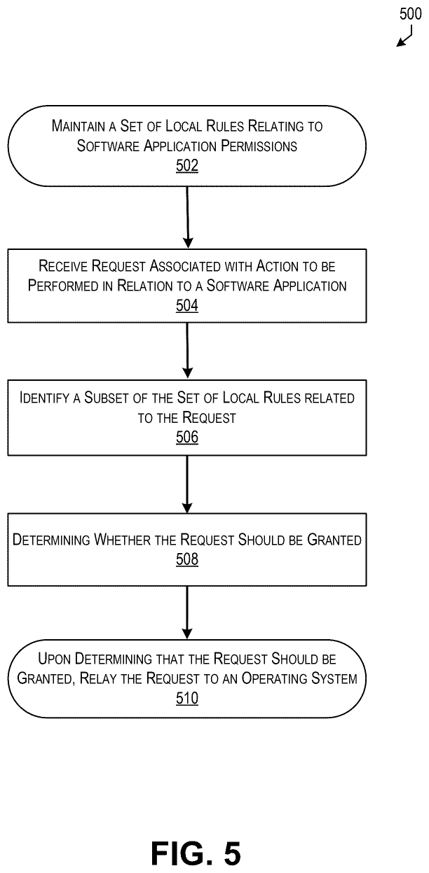

FIG. 5 depicts a flow diagram illustrating an exemplary process for enabling dynamic implementation of application permissions in accordance with at least some embodiments. The process 500 may be performed by components implemented on a user equipment, such as the user equipment 102 as described in relation to FIG. 1 above.

In embodiments, a module (e.g., rule enforcement module 210) implemented on a network node that operating on a network (e.g., a cellular network) may generate a set of local rules to be stored in local memory of a user equipment. The set of local rules may be generated by aggregating subsets of regional rules, account rules, performance rules, or any other suitable rules for regulating software application operations on a user equipment. The set of local rules may be generated by aggregating rules that relate to the user equipment on which the set of local rules are to be stored. For example, the set of local rules may include one or more rules that relate to a type of user or user account associated with the user equipment. In another example, the set of local rules may include one or more rules that relate to one or more technological capabilities of the user equipment. In another example, the set of local rules may include one or more rules that relate to a geographic region in which the user equipment is currently located.

In some cases, the set of local rules is generated based at least in part on a type of account maintained by the cellular network with respect to the user equipment device. In some cases, the set of local rules is generated based at least in part on a geographic region within which the user equipment device is located. In such cases, the set of local rules may be caused to be updated upon detecting that the user equipment is no longer located within the geographic region. Otherwise, the set of local rules may be generated on a periodic basis (e.g., each day, week, etc.) or when a request is received from the user equipment.

Once a local set of rules has been generated for a user equipment, the network node may provide that set of local rules to the user equipment. Upon receiving the set of local rules generated by the network node, the user equipment may store and maintain them in a local memory at 502. In embodiments, the user equipment device may be a mobile phone.

At 504, the process 500 may involve receiving, on the user equipment device, a request associated with an action to be performed in relation to a software application. In some embodiments, the request may be a request to install, update, uninstall, or roll back a current version of the software application. It should be noted that a request to update or roll back a current version of the software application may be a request to replace the data related to the software application with other data that relates to a different version of that software application.

At 506, the process 500 may involve identifying, from the set of local rules, a subset of the set of local rules related to the request. In embodiments, the subset of the set of local rules may be selected based on a type of the software application and/or the request. For example, if the software application is a gaming application, then the subset of local set of rules may include rules that relate to gaming applications in addition to any rules that relate to all software applications. Alternatively, if the request is a request to install a software application, the subset of the set of local rules may be selected to include rules that relate to installation of software applications as opposed to rules that relate to updating of software applications.

At 508, the process 500 may involve making a determination about whether the request should be granted based on the subset of the set of local rules. In embodiments, the determination about whether the request should be granted may be made based at least in part on a comparison of information about the request to one or more conditions associated with the subset of the set of local rules.

At 510, upon determining that the request should be granted, the process 500 may involve relaying the request to an operating system of the user equipment device to cause the user equipment device to execute one or more actions associated with the request. In some embodiments, a token to be used to verify authorization of the request may be provided to the operating system along with the request. In some cases, the token may be a verification token generated by a manufacturer of the user equipment device. In some cases, the token may be generated by a permission management module on the user equipment using information provided by the manufacturer of the user equipment.

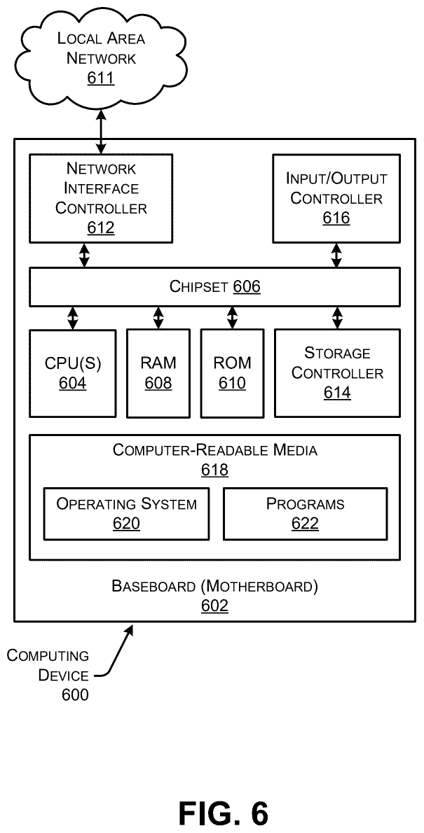

FIG. 6 shows an example computer architecture for a computing device 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a physical server as described herein, and may comprise networked devices such as servers, switches, routers, hubs, bridges, gateways, modems, repeaters, access points, etc.

The computing device 600 includes a baseboard 602, or “motherboard,” which is a printed circuit board to which a multitude of components or devices can be connected by way of a system bus or other electrical communication paths. In one illustrative configuration, one or more central processing units (CPU 604) operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 611. The chipset 606 can include functionality for providing network connectivity through a NIC 612, such as a gigabit Ethernet adapter. The NIC 612 is capable of connecting the computing device 600 to other computing devices over the network 611. It should be appreciated that multiple NICs 612 can be present in the computing device 600, connecting the computer to other types of networks and remote computer systems.

The computing device 600 can be connected to a storage device 618 that provides non-volatile storage for the computer. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by devices as described herein may be supported by one or more devices similar to computing device 600. Stated otherwise, some or all of the operations performed by an edge device, and/or any components included therein, may be performed by one or more computer device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to the other figures. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

As described herein, the computing device 600 may include one or more hardware processors (processors) configured to execute one or more stored instructions. The processor(s) may comprise one or more cores. Further, the computing device 600 may include one or more network interfaces configured to provide communications between the computing device 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the computing device 600 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause computing device 600 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
maintaining, on a user equipment device, a set of local rules that relate to software application permissions;
receiving, on the user equipment device, a request associated with an action to be performed in relation to a software application;
identifying, from the set of local rules, a subset of the set of local rules related to the request;
making a determination about whether the request should be granted based on the subset of the set of local rules; and
upon determining that the request should be granted, relaying the request to an operating system of the user equipment device to cause the user equipment device to execute one or more actions associated with the request.

2. The method of claim 1, wherein the determination about whether the request should be granted is made based at least in part on a comparison of information about the request to one or more conditions associated with the subset of the set of local rules.

3. The method of claim 1, further comprising providing, to the operating system along with the request, a token to be used to verify authorization of the request.

4. The method of claim 3, wherein the token comprises a verification token generated by a manufacturer of the user equipment device.

5. The method of claim 1, wherein the set of local rules is received from a network node operating on one of a cellular network or a WiFi network.

6. The method of claim 1, wherein the request comprises a request to install, update, uninstall, or roll back a current version of the software application.

7. The method of claim 1, wherein the set of local rules comprise one or more rules that relate to a type of user or user account associated with the user equipment.

8. The method of claim 1, wherein the set of local rules comprise one or more rules that relate to one or more technological capabilities of the user equipment.

9. The method of claim 1, wherein the set of local rules comprise one or more rules that relate to a geographic region in which the user equipment is currently located.

10. A user equipment device comprising:
one or more processors; and
one or more non-transitory computer-readable media storing computer-executable instructions that, when executed by the one or more processors, cause the user equipment device to perform operations comprising:
maintaining a set of local rules that relate to software application permissions;
receiving, on the user equipment device, a request associated with an action to be performed in relation to a software application;
identifying, from the set of local rules, a subset of the set of local rules related to the request;
making a determination about whether the request should be granted based on the subset of the set of local rules; and
upon determining that the request should be granted, relaying the request to an operating system of the user equipment device to cause the user equipment device to execute one or more actions associated with the request.

11. The user equipment device of claim 10, wherein the user equipment device comprises a mobile phone.

12. The user equipment device of claim 10, wherein the set of local rules are generated by a computing node operating on a cellular network.

13. The user equipment device of claim 12, wherein the set of local rules is generated based at least in part on a type of account maintained by the cellular network with respect to the user equipment device.

14. The user equipment device of claim 12, wherein the set of local rules is generated based at least in part on a geographic region within which the user equipment device is located.

15. The user equipment device of claim 14, wherein the set of local rules is caused to be updated upon detecting that the user equipment is no longer located within the geographic region.

16. The user equipment device of claim 10, wherein the request comprises a request to update or install the software application on the user equipment.

17. One or more non-transitory computer-readable media storing computer-executable instructions that, when executed by one or more processors, cause the one or more processors to perform operations comprising:
maintaining a set of local rules that relate to software application permissions;
receiving a request associated with an action to be performed in relation to a software application;
identifying, from the set of local rules, a subset of the set of local rules related to the request;
making a determination about whether the request should be granted based on the subset of the set of local rules; and
upon determining that the request should be granted, relaying the request to an operating system of the computer-readable media to cause the or more processors to execute one or more actions associated with the request.

18. The one or more non-transitory computer-readable media of claim 17, wherein the subset of the set of local rules may be selected based on a type of the software application.

19. The one or more non-transitory computer-readable media of claim 17, wherein the subset of the set of local rules may be selected based on a type of the request.

20. The one or more non-transitory computer-readable media of claim 17, wherein the determination about whether the request should be granted is made based at least in part on a comparison of information about the request to one or more conditions associated with the subset of the set of local rules.
